(19) United States
(12) Patent Application Publication
(10) Pub. No.: US 2017/0273282 A1
(43) Pub. Date: Sep. 28, 2017

(54) AQUACULTURE HEATING DEVICE

(71) Applicant: APOLLO SUN GLOBAL CO., LTD., San Jose, CA (US)

(72) Inventor: RICHARD CHI-HSUEH, SAN JOSE, CA (US)

(21) Appl. No.: 15/082,031

(22) Filed: Mar. 28, 2016

(51) Int. Cl. A01K 63/06; H05B 3/34

(52) U.S. Cl. CPC A01K 63/065; H05B 3/347; H05B 2203/015; H05B 2203/021

(57) ABSTRACT

This invention is related to an aquaculture heating device. A heating unit is hung on a support rod, so that the support rod can be horizontally placed above an aquaculture and two ends of the support rod can be fixedly positioned on two sides of the aquaculture to let the heating unit hung on the support rod to be dropped and immersed in the water of the aquaculture when winter, especially cold stream, comes. When electricity is provided to conductive yarns of a heating layer of the heating unit, heating filaments of the conductive yarns will generate heat to be transferred to the water and gradually diffused throughout the aqua culture through the waterproof fabric layer. Thus, the water temperature is raised to effectively help the aquatic organisms to resist the cold winter and not to be frozen to death caused by the very low water temperature.

### BACKGROUND

Field of Invention

The disclosure relates to an aquaculture heating device. More particularly, the disclosure relates to an aquaculture heating device having a support rod, and a heating unit hung on the support rod to be immersed in the water of an aquaculture to directly heat the water, so that the aquatic organisms in the aquaculture can be prevented from being frozen to death.

Description of Related Art

Most of the available outdoor aquacultures are located in open areas. In summers, the water temperature of the aquacultures is raised. In winters, the water temperature is decreased. Especially when cold stream comes, the water temperature will be decreased in a greater magnitude. Since the fishes and shrimps are cold-blooded, the body temperature thereof will be decreased as the environmental temperature is decreased. When the body temperature is too low, problems of poor blood circulation and oxygen deficient will occur to cause death.

Most of the presently adopted winter protection methods are building wind scaffoldings, digging wintering trenches, covering styrofoam plates or bubble cloth, extracting groundwater, or erecting heat lamps or electric heaters. However, using those methods have drawbacks. For example, cold wind can blow into aquacultures from the gaps between wind scaffoldings, and the insulation effect to keep the water temperature of the aquaculture is limited. In another example, the wintering trenches may keep the water temperature of the deep water at a temperature of about 4° C. However, when cold stream comes, the cultured fishes and shrimps may still be frozen to death caused by the water convection. In yet another example, covering styrofoam plates or bubble cloth above the water may decrease the water convection under low temperature to decrease the heat loss, but the dissolved oxygen in the water may be deficient to make the cultured fishes and shrimps dead since oxygen deficient. In yet another example, extracting the ground water having a higher temperature can raise the water temperature of the aquaculture, but it will cause land subsidence. Erecting heat lamps or electric heaters surrounding aquacultures can only increase the water surface temperature at most, since the heat lamps or electric heaters cannot be immersed in the water and thus only limited winter proofing effect is produced.

Therefore, in view of the drawbacks of the adopted winter proofing methods above, which cannot effectively prevent the fishes and shrimps from being frozen to death when cold winter comes, the inventors develop this invention by the many-year manufacturing and design experience and knowledge in the related fields and ingenuity.

### SUMMARY

This invention is related to an aquaculture heating device. One main aspect is to provide an aquaculture heating device having a heating unit on a support rod, and the heating unit is immersed in water to directly heat the water for avoiding the aquatic organisms being frozen to death.

For reaching the practical purposes, the inventors invent the following aquaculture heating device, which comprises:

at least a heating unit having at least two waterproof fabric layers covering a heating layer, wherein the heating layer comprises at least a heating fabric comprising multiple conductive yarns in a first direction and multiple nonconductive yarns in a second direction, as well as multiple metal conductive filaments disposed on two sides of the heating fabric and in a direction parallel to the second direction to be interwoven with the conductive yarns in the first direction, wherein the conductive yarns and the nonconductive yarns are interwoven as warps and wefts, and wherein the conductive yarns each has a nonconductive axial yarn spiral-wound by a heating filament; and

a suspension unit comprising a support rod having at least a binding part, wherein one terminal of the binding part disposed on the support rod and the other terminal of the binding part assembled with the heating unit.

In the aquaculture heating device above, the heating layer comprises multiple heating fabrics and a fixing element for fixing the heating fabrics.

In the aquaculture heating device above, a diameter of the heating filaments of the conductive yearns in the heating fabric is 0.02-0.12 mm.

In the aquaculture heating device above, a winding number of the heating filaments of the conductive yarns on the axial yarns in the heating fabric is 70-125 circles/cm.

In the aquaculture heating device above, a distribution width of is the metal conductive filaments on two sides of the heating fabric is about 0.6-1.0 cm.

In the aquaculture heating device above, a diameter of the metal conductive filaments is 0.05-0.12 mm.

In the aquaculture heating device above, the metal conductive filaments on two sides of the heating fabric are collectively connected to one ends of two conductive wires, and the other ends of the two conductive wires are penetrated outwardly from the waterproof fabric layer.

In the aquaculture heating device above, the other ends of the two conductive wires of the heating layer of the heating unit that outside the waterproof fabric layer are electrically connected to a power supply unit converting AC electricity to DC electricity and being connected to a control unit.

In the aquaculture heating device above, one end of the support rod of the suspension unit is further connected to a furling unit having a motive power unit.

In the aquaculture heating device above, the motive power unit is one of an electrical power unit and a manual power unit.

Therefore, when winter, especially cold stream, comes, the support rod can be horizontally placed above an aquaculture, two ends of the support rods are positioned on two sides of the aquaculture, so that the heating unit hung on the support rod can be immersed in the water of is the aquaculture. When electricity is provided to the conductive yarns of the heating layer in the heating unit, the heating filaments in the conductive yarns will generate heat and the heat can be transferred to water through the outer waterproof fabric layer and diffused to the surrounding corners to raise the water temperature of the aquaculture. Therefore, the aquatic organisms in the aquaculture can resist the cold winter to avoid being frozen to death caused by the very low water temperature.

### BRIEF DESCRIPTION OF THE DRAWINGS

FIG. 1 is an overall perspective view of one embodiment of this invention.

FIG. 2 is a perspective view of a heating unit according to this invention.

FIG. 3 is a knitting diagram of a heating unit according to this invention.

FIG. 4 is a front view of a conductive yarn of this invention.

FIG. 5 is a front view of a conductive-yarn manufacturing device of this invention.

FIG. 6 is an overall perspective view of another embodiment of this invention.

FIG. 7 is a using diagram of another embodiment of this invention.

### DETAILED DESCRIPTION

To more completely and clearly illustrate the technical means and effects of this invention, the detailed descriptions are set forth below. Please refer to the disclosed figures and the reference numbers.

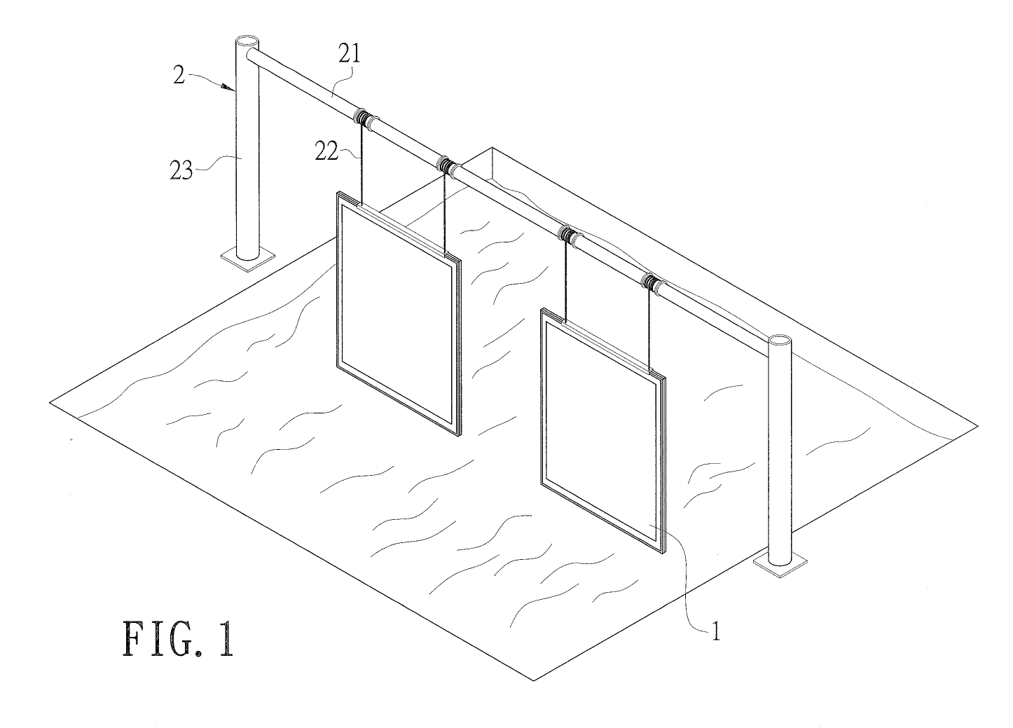

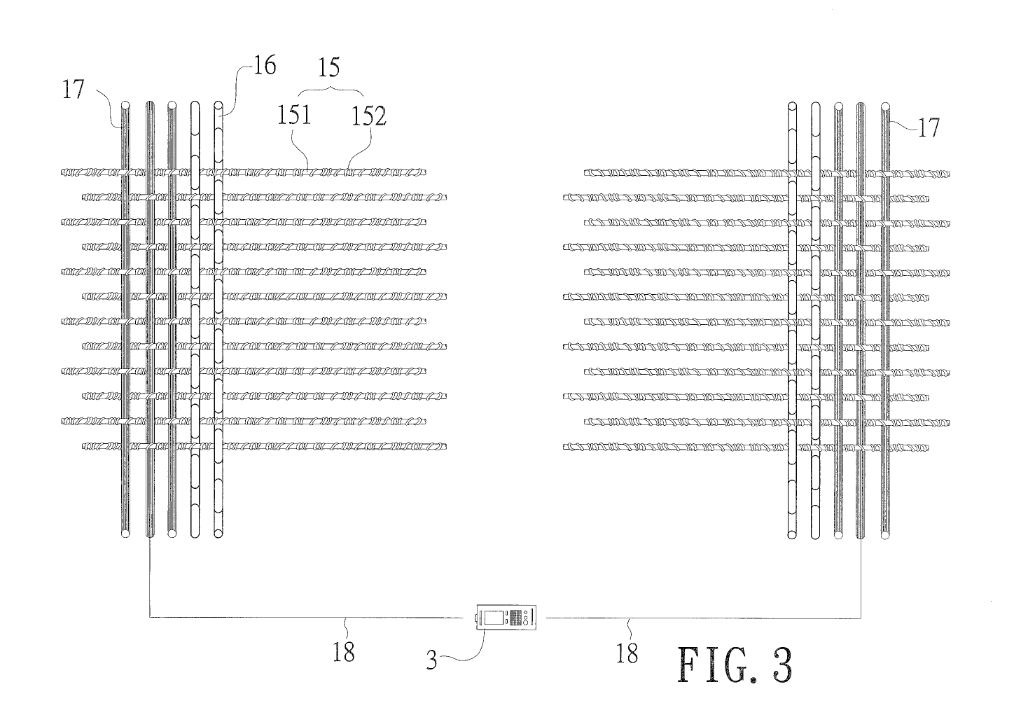

First, please refer to FIG. 1, which is an overall perspective view of one embodiment of this invention. The heating device comprises a heating unit 1, a suspension unit 2, and a power supply unit 3 (shown in FIG. 3).

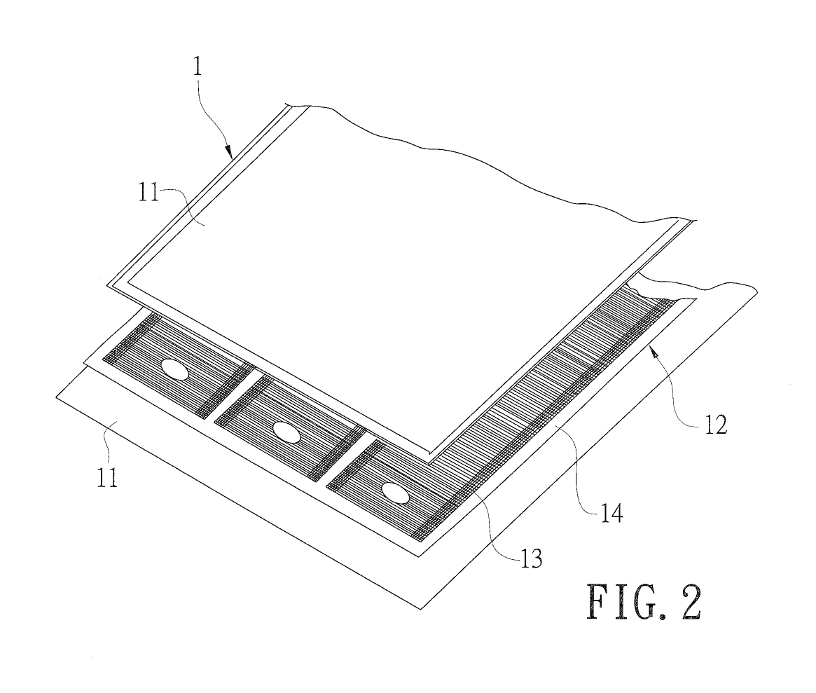

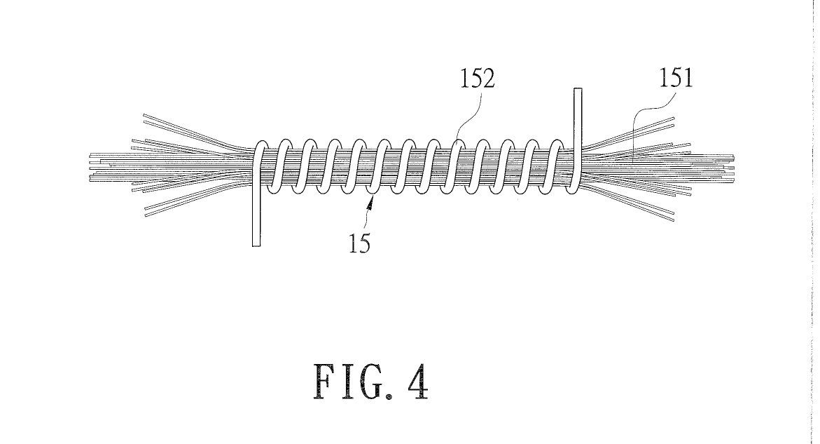

Please also refer to FIGS. 2-4. The heating unit 1 has two waterproof fabric layers 11 and a heating layer 12 sandwiched by the two waterproof fabric layers 11. The heating layer 12 comprises at least a heating fabric 13. In one embodiment of this invention, there are multiple heating fabrics 13 fixed on a fixing element 14 made by a fibrous fabric. The heating fabrics 13 comprises multiple conductive yarns 15 to be fibers in a first direction and multiple nonconductive multi-core yarns 16 to be fibers in a second direction. In this invention, the fibers in the first direction are used as wefts, and the fibers in the second direction are used as warps. Therefore, the conductive yarns 15 in the weft direction and the nonconductive yarns 16 in the warp direction are alternatively knitted. The conductive yarns 15 each has a multi-core filament to be a nonconductive axial yarn 151 spirally-wound by a heating filament 152. The heating filament 152 is made by Au, Ag, Cu, W or Mo, etc. for enerating heat after electrically conducting. The diameter of the heating filaments 152 is preferred to be 0.02-0.12 mm. The winding number of the heating filaments 152 is preferred to be 70-125 circles one each centimeter of the axial yarn 151. Multiple metal conductive filaments 17 are disposed on two sides of the heating fabric 13. The metal conductive filaments 17 are made of Cu or Ag, and the diameter of the metal conductive filaments 17 is preferably 0.05-0.12 mm. The distribution width of the metal conductive filaments 17 are preferably 0.6-1.0 cm. The multiple metal conductive filaments 17 are parallel with the nonconductive yarns 16 in the second direction, and alternatively knitted with the conductive yarns 15 in the first direction to form a conductive path. The metal conductive filaments 17 distributed on one side of the heating fabric 13 are collectively connected to one ends of two conductive wires 18, and the other ends of the two conductive wires 18 are penetrated outwardly from the waterproof fabric layer 11. At the location that the metal wires 17 penetrate from the waterproof fabric layer 11, waterproof glue, such as silicone, is coated to perform waterproofing.

The suspension unit 2 comprises a support rod 21. One end of a binding part 22 is disposed on the support rod 21, and the heating unit 1 is disposed on the other end of the binding part 22. The binding part 22 may be a sling. A standing frame body 23 is assembled on two ends of the support rods 21.

A power supply unit 3 is electrically connected to the other ends of the two conductive wires 18 penetrating outwardly from the waterproof fabric layer 11. The power supply unit 3 is equipped with a plug to connect with a socket of an electric supply to decrease the AC voltage of 110-220 V to a DC power supply with low voltage of 6 V, 12 V, 24 V, and 48 V. The power supply unit 3 is electrically connect to a control unit, which controls the heating temperature, time and on/off

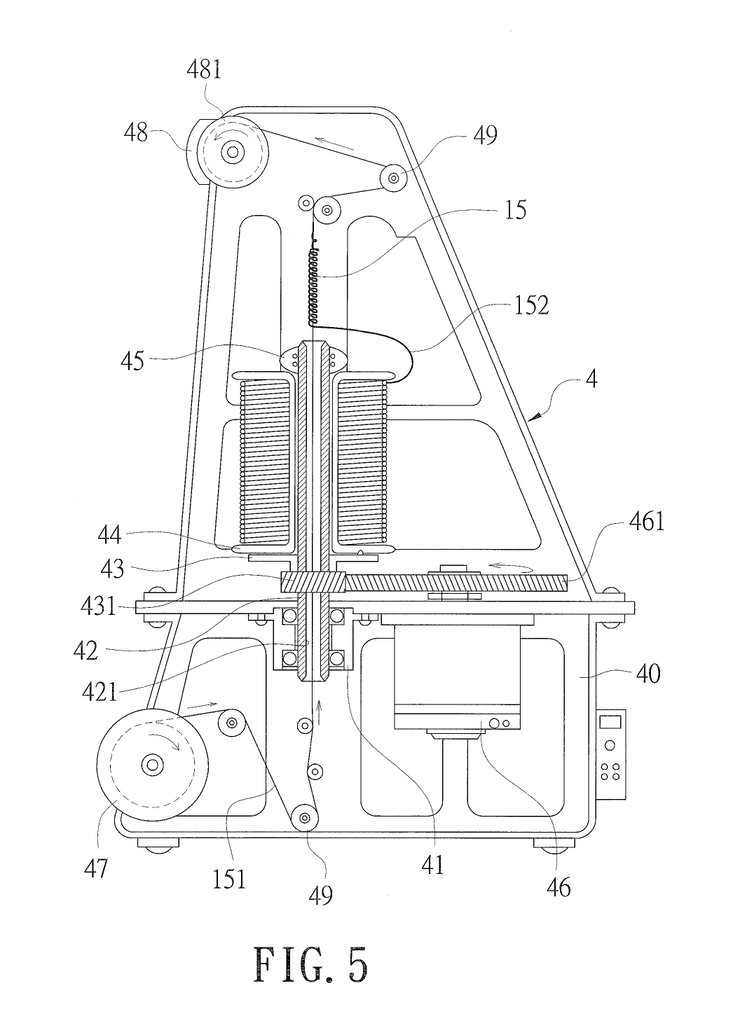

Accordingly, the heating fabric 13 is manufactured by a conductive-yarn manufacturing device 4, please refer to FIG. 5. The conductive-yarn manufacturing device 4 comprises a body 40, and a positioning seat 41 disposed on the body 40. The positioning seat 41 is correspondingly assembled with an axial rod 42 having a central axial hole 421. The axial rod 42 is assembled with a rotating seat 43. The bottom of the rotating seat 43 is combined with a rotating wheel 431. The top of the rotating seat 43 is combined with a reel 44 wound by a heating filament 152 made by a tiny metal filament. A stopper 45 is disposed on the top of the axial rod 42 to position the reel 44. A first motive power source 46 is fixedly disposed on the body 40 and assembled with a driving wheel 461 engaged with the rotating wheel 431. is A spindle fixed disk 47 is disposed on the bottom of the body 40 for winding the axial yarn 151. A second motive power source 48 is disposed on the top of the body 40 and assembled with a spindle furling disk 481.

When a conducive yarn is made, the spindle of the nonconductive yarn is fixed on the spindle fixed disk 47 at the bottom of the body 40 to provide the nonconductive axial yarn 151 wound by a heating filament 152. The heating filament 152 circles on the reel 44 above the rotating seat 43. Subsequently, the spindle furling disk 481 assembled with the second motive power source 48 pull the axial yarn 151 guided by several guiding wheels 49 assembled on the body 40 to let the axial yarn 151 penetrate the central axial hole 421 of the axial rod 42, and then the axial yarn 151 is pulled up to be delivered to the reel 44 circled by the heating filament 152. The rotating wheel 431 is driven by the first motive power source 46 through the driving wheel 461 to make the reel 44 assembled on the rotating seat 43 rotate in a high speed, so that the heating filament 152 can be parabolically thrown out to spirally circle the axial yarn 151 to form the conductive yarn 15 of this invention. The conductive yarn 15 is pulled, transferred, and rotatively received by the spindle furling disk 481 through the several guiding wheels 49 in a certain direction. A recorder is set at the position of the spindle furling disk 481 to calculate the length of the conductive yarn 15 received by the spindle furling disk 481. When a predetermined length of the conductive yarn 15 on the spindle furling disk 481 is reached, the conductive yarn 15 may be sent to a textile factory to be a weft when knitting. The conductive yarn 15 as the weft can be spun with the nonconductive yarn 16 containing multi-core filaments as the warp to form the heating fabric 13.

When winter, especially cold stream, comes, a user can take the aquaculture heating device of this invention to horizontally place the support rod 21 of the suspension unit 2 above an aquaculture. The frame bodies 23 are used to support the support rod 21 and positioned on two sides of the aquaculture. At this time, the heating unit 1 hung on the support rod 21 will naturally fall down to be immersed in the water of the aquaculture. The user can set up several aquaculture heating devices in one aquaculture. Therefore, when these aquaculture heating devices are used, the user can turn on the power supply unit 3 through the control unit to convert the AC power of 110-220 V to a DC power of 12 V or 24 V and then output the DC power through the conductive wires 18 to the metal conductive filaments 17 of the heating fabric 13 of the heating unit 1 and then the conductive yarns 15. Thus, the conductive filaments 152 of the conductive yarns 15 can generate heat to be transferred to the water through the waterproof fabric layer 11 and then throughout the aquaculture to raise the temperature of the water in the aquaculture. Therefore, the aquatic organisms, such as fishes and shrimps, will not be frozen to death caused by the very low water temperature. In addition, the heating temperature and time can be adjusted by the control unit, depend on the water temperature. The heating temperature and time may be increased as the water temperature is decreased to more effectively prevent the aquatic organisms from being frozen to death. Especially, low voltage and small current is used to provide electricity to the heating fabric 13 for generating heat. Hence, the power consumption can be effectively decreased. Moreover, the harm of the electromagnetic wave to the aquatic organisms can be decreased, and the current leakage under high voltage can be avoided to prevent the aquatic organisms from being killed by electric shock.

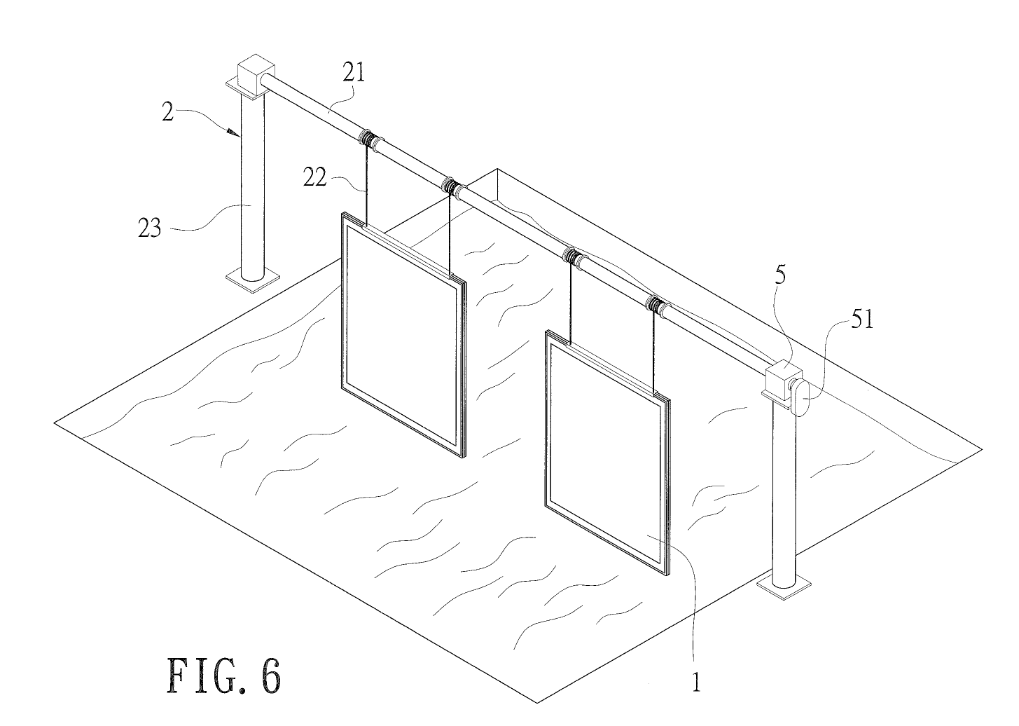

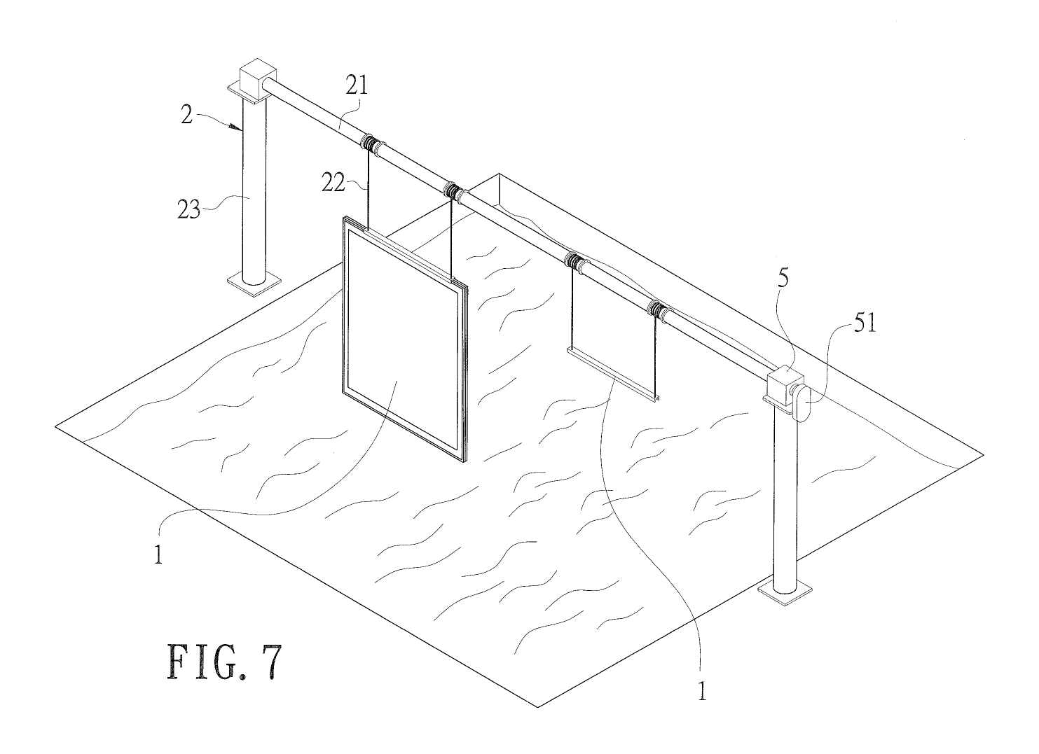

After the winter or the cold stream, the aquaculture heating device of this invention can be removed from the aquaculture to prevent the heating unit 1 from being damaged by aquatic organisms' biting. Please refer to FIG. 6, too. According to another embodiment of this invention, a furling unit 5 is assembled on one end of the support rod 21. The furling unit 5 is connected to a motive power unit 51, which may be one of an electrical power unit and a manual power unit. Please also refer to FIG. 7. The motive power unit 51 can be used to drive the furling unit 5 and then rotate the support rod 21. Thus, the binding part 22 and the heating unit 1 assembled with the support rod 21 can be easily rotated on the support rod 21. Since the heating filaments 152 of the conductive yarns 15 in the heating layer 12 spirally wind on the axial yarns 151. Therefore, there is a good stretching space for the heating filaments 152 when the heating filaments 152 are in thermal expansion and contraction. In addition, the heating filaments 152 spirally winding on the axial yarns 151 can protect the heating filaments 152 from being broken. The heating layer 12 of this invention is soft and flexible like a cloth, such that the heating unit 1 can be easily unfolded for using and folded for stacking and storage.

The foregoing embodiments or figures are not used to limit the scope of the aquaculture heating device in this invention. In this invention, the fixing elements 14 may be omitted, and the heating fabric 13 can be directly woven to have a needed size. The two ends of the support rod 21 are positioned on two sides of an aquaculture. Any proper variations and modifications made by persons skilled in the art should be viewed as not depart from the scope of the aquaculture heating device in this invention.

From the structures and embodiments above, it is known that this invention has the following advantages.

1. In this invention, the aquaculture heating device is immersed deeply in the water of the aquaculture to heat the water of the aquaculture. The heat generated by the heating unit can be diffused throughout the aquaculture to raise the water temperature to more effectively avoid the aquatic organisms from being frozen to death caused by the very low water temperature.

2. In this invention, the heating unit of the aquaculture heating device is connected to a power supply unit and a control unit. Therefore, a user can actively adjust the heating temperature and time of the heating unit to match the decreased water temperature and more effectively avoid the aquatic organisms from being frozen to death.

3. In this invention, one end of the support rod of the suspension unit of the aquaculture heating device is equipped with a furling unit. Therefore, a user can rotate the support rod through the furling unit to furl the binding unit and the heating unit on the support rod.

4. In the heating layer of the heating unit of the aquaculture heating device of this invention, the heating filaments spirally circulate the axial yarn. Accordingly, there is a good stretching space for the heating filaments as in a state of thermal expansion and contraction. In addition, the heating filaments spirally winding on the axial yarns is soft and flexible to protect the heating filaments from being broken. Therefore, the heating unit can be easily unfolded for using and folded for stacking and storage.

5. In this invention, the aquaculture heating device uses low voltage and small current. Hence, the power consumption can be effectively decreased to obtain the effect of energy saving and carbon reducing. Moreover, the harm of the electromagnetic wave to the aquatic organisms can be decreased, and the current leakage under high voltage can be avoided to prevent the aquatic organisms from being is killed by electric shock.

What is claimed is:

1. An aquaculture heating device, comprising:
at least a heating unit having at least two waterproof fabric layers covering a heating layer, wherein the heating layer comprises at least a heating fabric comprising multiple conductive yarns in a first direction and multiple nonconductive yarns in a second direction, as well as multiple metal conductive filaments disposed on two sides of the heating fabric and in a direction parallel to the second direction to be interwoven with the conductive yarns in the first direction to form a conductive path, wherein the conductive yarns and the nonconductive yarns are interwoven as warps and wefts, and wherein the conductive yarns each has a nonconductive axial yarn spiral-wound by a heating filament; and
a suspension unit comprising a support rod having at least a binding part, wherein one terminal of the binding part disposed on the support rod and the other terminal of the binding part assembled with the heating unit.

2. The aquaculture heating device of claim 1, wherein the heating layer comprises multiple heating fabrics and a fixing element for fixing the heating fabrics.

3. The aquaculture heating device of claim 1, wherein a diameter of the heating filaments of the conductive yearns in the heating fabric is 0.02-0.12 mm.

4. The aquaculture heating device of claim 1, wherein a winding number of the heating filaments on the axial yarns of the conductive yarns in the heating fabric is 70-125 circles/cm.

5. The aquaculture heating device of claim 1, wherein a distribution width of the metal conductive filaments on two sides of the heating fabric is about 0.6-1.0 cm.

6. The aquaculture heating device of claim 1, wherein a diameter of the metal conductive filaments is 0.05-0.12 mm.

7. The aquaculture heating device of claim 1, wherein the metal conductive filaments on two sides of the heating fabric are collectively connected to one ends of two conductive wires, and the other ends of the two conductive wires are penetrated outwardly from the waterproof fabric layer.

8. The aquaculture heating device of claim 7, wherein the other is ends of the two conductive wires of the heating layer of the heating unit that outside the waterproof fabric layer are electrically connected to a power supply unit converting AC electricity to DC electricity and being connected to a control unit.

9. The aquaculture heating device of claim 1, wherein one end of the support rod of the suspension unit is further connected to a furling unit having a motive power unit.

10. The aquaculture heating device of claim 9, wherein the motive power unit is one of an electrical power unit and a manual power unit.
